(19) United States
(12) Patent Application Publication
(10) Pub. No.: US 2016/0103623 A1
(43) Pub. Date: Apr. 14, 2016

(54) METHOD FOR CONTROLLED COLLISION OF HASH ALGORITHM BASED ON NAND FLASH MEMORY

(71) Applicant: Industry Academic Cooperation Foundation of Yeungnam University, Gyeongsan-si (KR)

(72) Inventors: Gyu Sang Choi, Suseong-gu (KR); Woong Kyu Park, Suseong-gu (KR); Sung Chul Kim, Suseong-gu (KR)

(21) Appl. No.: 14/801,774

(22) Filed: Jul. 16, 2015

(30) Foreign Application Priority Data
Oct. 14, 2014 (KR) 10-2014-0138418

(51) Int. Cl. G06F 3/06

(52) U.S. Cl. CPC G06F 3/0619; G06F 3/064; G06F 3/0679

(57) ABSTRACT

The following description provides method for controlled collision of hash algorithm based on NAND flash memory improving data process performance by applying a hash structure on an optimized data structure in a NAND flash memory, using a coalesced chaining scheme. Further, the following description provides a method for controlled collision of hash algorithm based on NAND flash memory including a) setting one bucket size and an NAND flash memory page size identical; and b) storing a record regarding a plurality of hash values in the one bucket in NAND flash memory based hash index method. Further, when using a coalesced chaining and bucket separation scheme on a coalesced chaining scheme, storage space smaller than the separation chaining scheme, fast insert, fast retrieving are all possible, thereby data processing may be improved.

### CROSS-REFERENCE TO RELATED APPLICATION(S)

This application claims the benefit under 35 USC 119(a) of Korean Patent Application No. 10-2014-0138418 filed on Oct. 14, 2014 in the Korean Intellectual Property Office, the entire disclosure of which is incorporated herein by reference for all purposes.

### BACKGROUND

1. Field

The following description relates to a method for controlled collision of has algorithm based on NAND flash memory and a method for controlled collision of hash algorithm based on NAND flash memory improving data process performance by applying a hash structure on an optimized data structure in a NAND flash memory.

Recently, a NAND (negative AND) flash memory based storage device is used a lot in a computer system because of various advantages such as a high performance compared to an HDD, low power consumption, high credibility and small form factor and etc. After the year 2009, market size of a SSD (Solid State Drive) is expected grow rapidly every year.

However, market share of the NAND flash memory is yet much lower than that of the HDD because cost unit of the NAND flash memory is higher than HDD. Further, the NAND flash memory is not showing a better performance than HDD regarding certain works such as a random write.

2. Description of Related Art

Performing read operation of all slots linking with a linkage list every time when collision occurs to store data as much as a storage device is required to be possible of random access and preferable in an environment such as a RAM (Random Access Memory) with very fast access speed. Although read speed of the NAND flash memory is faster than a HDD but much slower compared to the RAM, hence difficult to directly apply on an NAND flash memory environment.

Further, minimum read unit of the NAND flash memory is a page unlike RAM with bit as a minimum read unit may be problem of a separation chaining scheme. Continuous read/write operation of a page unit to read one small record is a big loss. An optimized hash table includes a bucket and a slot according to the number of records. However, the optimized record will be continuously input and deleted thereby determination of a bucket size is difficult considering changing index material structure.

A method of showing a good performance when the number of records changes is making a size of a bucket and an NAND flash memory identical. However, the method has a disadvantage in that storage space is required much more than the actually required size in a hash table where collision is not occurred often.

The best hash function is a condition of collision rarely occurring and a hash function well distributed. However, when setting the bucket size of a separation chaining scheme with a page unit of a flash memory that is much bigger than a sector unit of a HDD, resource waste of a storage device worsens and decrease hit rate of a memory buffer. Accordingly, performance of an entire hash table may be degraded. Further, a hash with frequently occurred collision is known to be further effective to rarely occur collision through re-hashing that use other hash function.

However, regarding the afore-mentioned has algorithm of related art, there are two following problems in a separation chaining scheme. First, a storage space that is not used required a lot. Second, buffer hit rate decreases accordingly hence, performance is degraded.

### SUMMARY OF THE INVENTION

The following description provides method for controlled collision of hash algorithm based on NAND flash memory improving data process performance by applying a hash structure on an optimized data structure in a NAND flash memory, using a coalesced chaining scheme.

The following description provides a method for controlled collision of hash algorithm based on NAND flash memory including a) setting on bucket size and an NAND flash memory page size identical; and b) storing a record regarding a plurality of hash value in the one bucket in NAND flash memory based hash index method.

A slot place that may be stored in the one bucket according to respective values is set and a record may be stored in a related place when a record of a hash value regarding the set slot place is called.

When a record that occurs collision with a same hash value is called to the set slot, when there is an empty space in the bucket, the empty bucket is recorded and may be linked to a last record with collision occurred through an index.

Although there is a record in the set slot, when the record is not a record relating to a determined has value, change the record of the related place with a new record. Further, when there is an empty slot in a bucket, the changed record may be stored in that place.

When there is no empty slot in the bucket, the bucket may be separated and stored by narrowing the range of the hash value that can be stored in the bucket thereby reducing a read overhead.

Retrieving performance maybe improved through an index of respective records in one bucket by applying a coalesced chaining algorithm to the records therebetween.

When collision of over reference value occurs, records of the bucket are divided and distributed to reduce a range sharing at least one bucket and the directory data is changed to a new data.

According to a method for controlled collision of has algorithm based on NAND flash memory of a present description, when using a coalesced chaining and bucket separation scheme on a coalesced chaining scheme, storage space smaller than the separation chaining scheme, fast insert, fast retrieving are all possible, thereby data processing may be improved.

Further, by changing the hash structure and applying on a data structure of a NAND flash memory, total write number total frequency of write may be reduced and nonvolatile RAM durability and data processing performance may be improved.

### BRIEF DESCRIPTION OF THE DRAWING

FIG. 1 is a flow chart illustrating a collision processing method of a hash algorithm based on a NAND flash memory according to an embodiment of the present description.

FIG. 2 to FIG. 5 are block diagrams illustrating a memory structure according to an application of an embodiment of the present description.

FIG. 6 to FIG. 8 are block diagrams illustrating a memory structure according to an application of an embodiment of the present description.

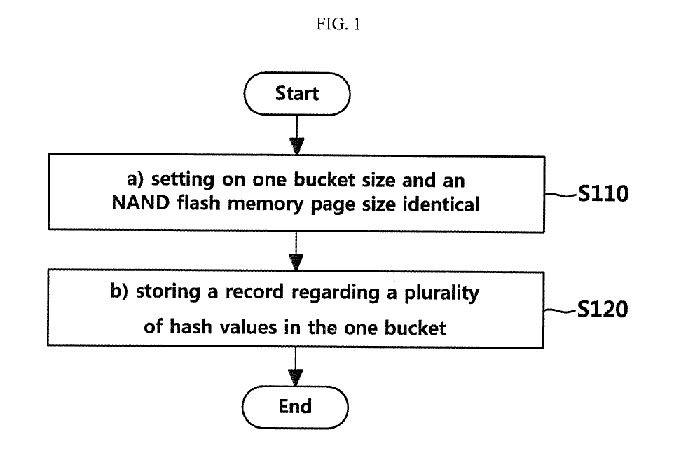

### DETAILED DESCRIPTION OF THE PREFERRED EMBODIMENT

Certain exemplary embodiments of the present inventive concept will now be described in greater detail with reference to the accompanying drawings. In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

A hash algorithm applied to the present description is one of a data structure with a random write frequently occurs. According to a feature of a NAND flash memory, the hash data structure is difficult of operating high performance in the NAND flash memory, thereby a hash that is optimized for a NAND flash memory is required. The hash algorithm use RAM and etc. as a buffer, thereby overcomes a disadvantage of a NAND flash memory with write slower than read. To use RAM as a buffer, buffer management scheme that is optimized for a NAND flash memory like CFLRU is used. Herein, a memory management method that may minimize write of a NAND flash memory is provided under the expectation that there is a high possibility that the recently used data may be called.

Overflow is generated very fast in the coalesced chaining scheme because a plurality of hash use one bucket. The coalesced chaining scheme have better use of storage space than the separation chaining scheme however, there is high possibility of performance degradation in a big data set that frequently generate collision. In order to compensate such disadvantage, a coalesced chaining scheme with a coalesced separation scheme applied is suggested.

More particularly, records regarding a plurality of hashes are inserted in a bucket not storing a record regarding one hash in a bucket.

The bucket size is identical with a page size and on average, one slot is distributed in one hash in the bucket. In other words, if there are four slots in the bucket, 4 hashes are stored in one bucket and a related index is stored in a directory.

Like a separation chaining scheme, when overflow is generated the bucket is linked with a link list and process a collision.

Since there is a record regarding various hashes at once, coalesced chaining scheme is applied to records therebetween. Thereby, retrieving performance may be improved through an index of respective records in one bucket.

When collision frequently occurs, a method preventing overflow by distributing records through dividing records of the bucket to reduce sharing range of one bucket, and changing data of a directory to a new data is used. When hash collision continuously occurs and separation continuously occurs and thereby, data regarding one hash for one bucket is only left. The form may be almost similar with a separation chaining scheme.

Hereinafter, an embodiment of the present description is illustrated in detail referring to the attached drawing.

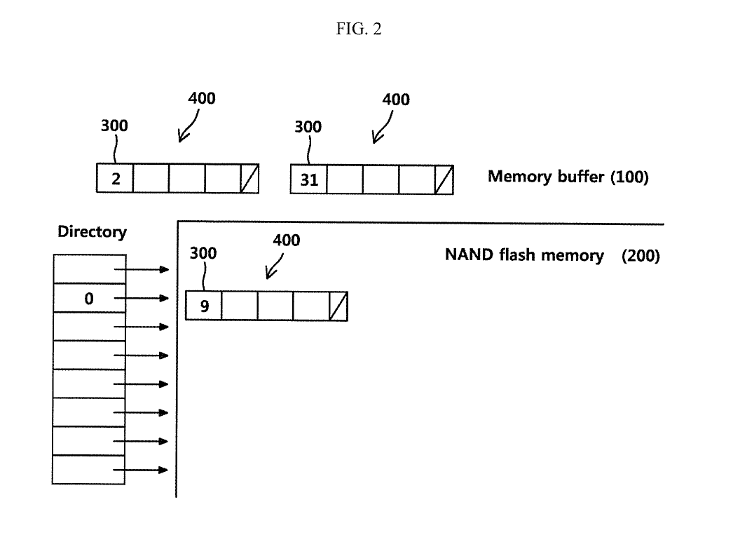

FIG. 2 to FIG. 5 are block diagrams illustrating a memory structure according to an application of an embodiment of the present description.

As illustrated, the present description includes a memory buffer 100, a NAND flash memory 200, a slot 300, and a bucket 400.

Referring to FIG. 2 to FIG. 5, one bucket 400 includes four slots 300 and a memory buffer 100 includes a space that may store two buckets 400 and a separate chaining that inserts a record of key 9, 31, 2, 11, 28, 33, 19, 8, 0, 29, 23, 13. Division of 8 (rest) is used as a hash function.

FIG. 2 is a result illustrating a key value 9, 31, 2 of a record is inserted according to an embodiment of the present description.

A record of a key value ‘2’ is inserted and a bucket starts to write on a disk. A hash of ‘9, 31, and 2’ are all different and since there is no more space hence, at first No.0 bucket 400 with a record of key value ‘9’ that is the smallest and used recently is written in a NAND flash memory 200 section (NAND flash memory write).

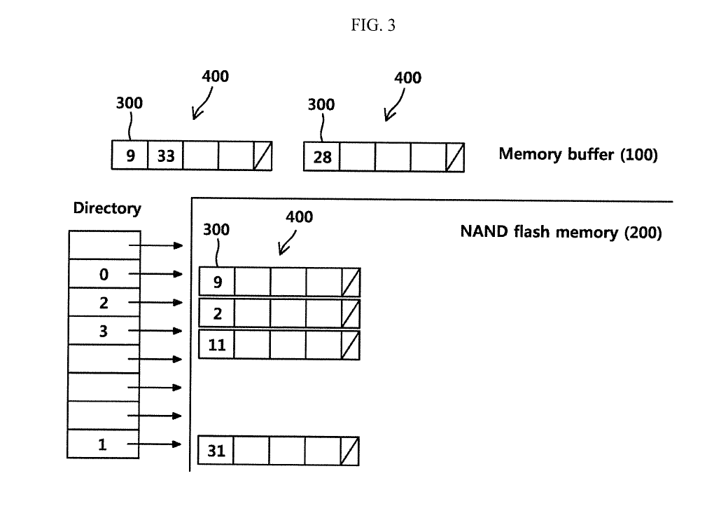

FIG. 3 illustrates a result of a record of key values ‘11, 28, 33’ inserted in the FIG. 2.

As illustrated in FIG. 3, collision is generated because key value ‘9 and 33’ of a hash value is identical. When collision occurs, the number ‘0’ No. 0 bucket stored in the NAND flash memory 200 is read through a directory to check for an empty slot 300 and loaded to the memory. Thereafter, an empty slot in a bucket 400 is checked and when there is a storage space for a record of a key value 33, the record of the key value 33 is stored in the storage space.

Since the bucket is still written in a memory buffer 100 and not written in the NAND flash memory 200, respective materials of a bucket 400 of the NAND flash memory 200 and the memory buffer 100 may be different. (read the NAND flash memory)

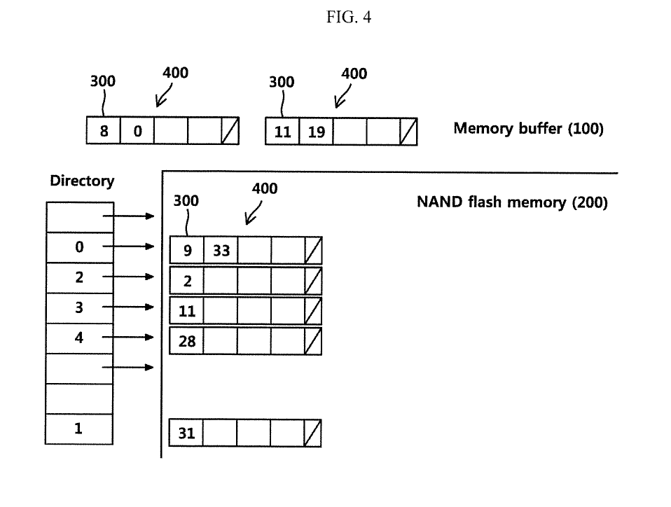

FIG. 4 illustrates a result of a record of key value ‘19, 8, 0’ inserted.

As illustrated in FIG. 4, a new bucket 400 is generated in the memory buffer 100 as a record of key value ‘8’ is generated. Further while a record of key value ‘0’ is in the memory buffer 100, a record of key value ‘8’ is inserted. Accordingly, read/write of the NAND flash memory 200 may not be generated. (memory buffer hit)

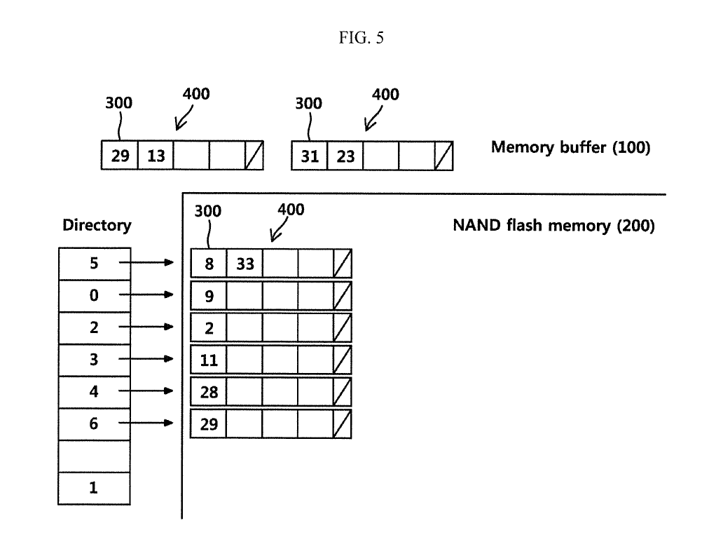

FIG. 5 illustrates a result with a record of key values ‘29, 23, 13’ are inserted to FIG. 4.

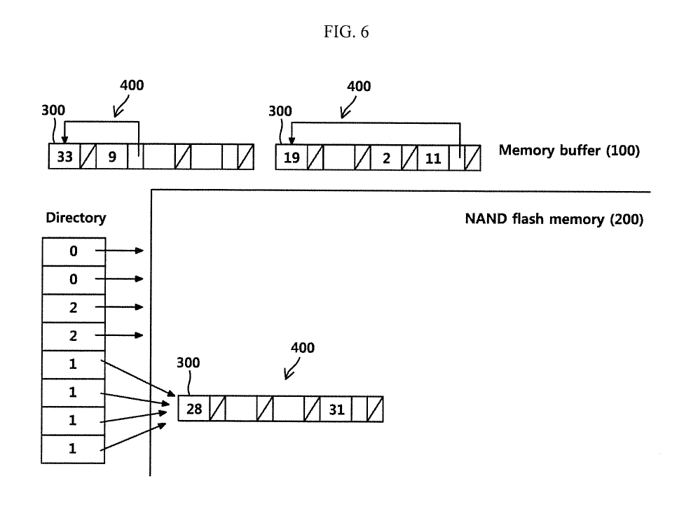

FIG. 6 to FIG. 8 are block diagrams illustrating a memory structure according to an embodiment of the present description.

FIG. 6 to FIG. 8 illustrate a merge chaining with split scheme including one bucket 400 including four slots 300 and the memory buffer 100 including a space of two buckets 400 may be storable and, a record of key values ‘9, 31, 2, 11, 28, 33, 19, 8, 0, 29, 23, 13’ is inserted.

A hash function uses a division of 8. In the case above, total of six memory buffer hits occur thereby, 26 times of a NAND flash memory write, 23 times of flash memory read occurs. Thus, a total of 231 time is consumed when calculated read as ‘1’ and write as ‘8.’

FIG. 6 illustrates a result of a record of key values ‘9, 31, 2, 11, 28, 33, 19’ are inserted.

When a record of key value 19 is inserted, for the first time a bucket performs write on the NAND flash memory 200. Since a record of a key value 19 has no further space in a bucket 400 to be inserted, the new bucket 400 should be generated. There is no further empty space in the memory so, at first the least used No. 1 bucket is written in the NAND flash memory 200 section. As a record is generated unlike the separation chain, a bucket 400 with many empty slots 300 is not written in the NAND flash memory 200 and big amount of information is written using the bucket 400 in the maximum. (NAND flash memory write, separation scheme).

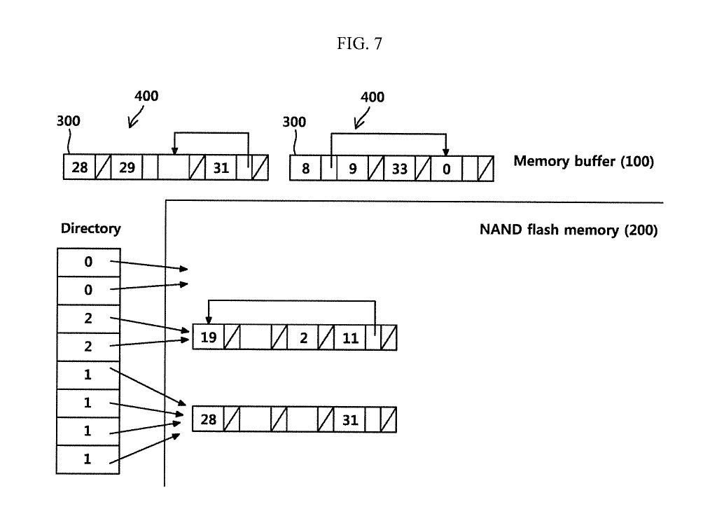

FIG. 7 illustrates a diagram a record of key values ‘8, 0, 29’ are inserted in the FIG. 6.

No. 1 bucket 400 of a NAND flash memory 200 is readed from a disk to store a record of key value ‘29’. Further, since there is no more space in the memory, the least recently used No. 2 bucket 400 is stored in the disk and the No. 1 bucket 400 exists in the memory buffer 100. (read NAND flash memory).

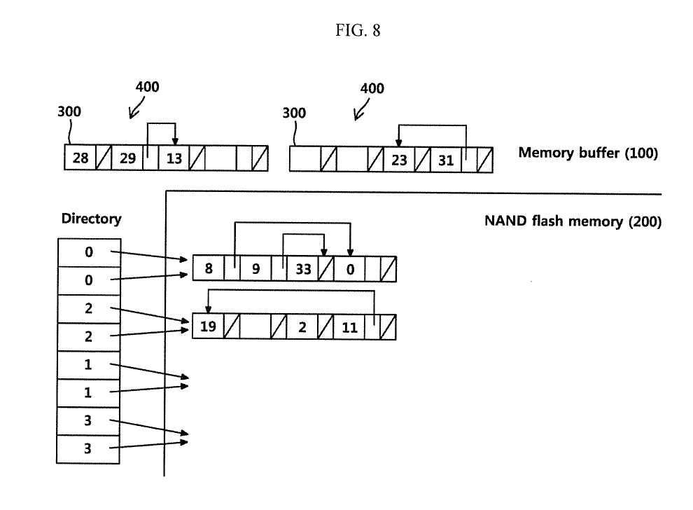

FIG. 8 illustrates a diagram with a record of key value ‘23, 13’ inserted in the FIG. 7.

According to a hash algorithm based on a NAND flash memory according to a present description, data processing performance may be improved because when a coalesced chaining and bucket separation scheme are used in a coalesced chaining scheme, use of a storage space smaller than a separation chaining scheme, fast insertion, and fast retrieving are all possible.

Further, by changing hash structure and by applying to the data structure of the NAND flash memory, total frequency of write is reduced and a durability of nonvolatile RAM data processing performance may be improved.

The preferred embodiments of the invention have been explained so far. a person skilled in the art will understand that the invention may be performed in modifications without departing from the basic characteristics of the invention. Accordingly, the foregoing exemplary embodiments and advantages are merely exemplary and are not to be construed as limiting the present disclosure. The present teaching can be readily applied to other types of apparatuses. Also, the description of the exemplary embodiments of the present inventive concept is intended to be illustrative, and not to limit the scope of the claims.

What is claimed is:

1. A method for controlled collision of hash algorithm based on a NAND flash memory of a hash index method based on a NAND flash memory, comprising:
a) setting one bucket size and an NAND flash memory page size identical; and,
b) storing a record regarding a plurality of hash values in the one bucket.

2. The method for controlled collision of hash algorithm based on a NAND flash memory of claim 1, wherein a slot place that may be stored in the one bucket according to respective values is set and the record may be stored in a related place when the record of a hash value regarding the set slot place is called.

3. The method for controlled collision of hash algorithm based on a NAND flash memory of claim 2, wherein when a record with a same hash value that occurs collision is already called to the set slot, when there is an empty space in the bucket, the empty bucket is recorded and may be linked to the last record with collision occurred through an index.

4. The method for controlled collision of hash algorithm based on a NAND flash memory of claim 2, wherein although there is a record in the set slot but when the record is not a record relating to a set hash value, change the record of the related place with a new record. Further, when there is an empty slot in a bucket, the changed record may be stored in that place.

5. The method for controlled collision of hash algorithm based on a NAND flash memory of claim 4, wherein when there is no empty slot in the bucket, the bucket may be separated and stored by narrowing the range of the hash value that can be stored in the bucket thereby reducing a read overhead.

6. The method for controlled collision of hash algorithm based on a NAND flash memory of claim 1, wherein retrieving performance maybe improved through the index of respective records in one bucket by applying a coalesced chaining algorithm to the records therebetween.

7. The method for controlled collision of hash algorithm based on a NAND flash memory of claim 1, wherein when collision of over reference value occurs, records of the bucket are divided and distributed to reduce a range sharing at least one bucket and the directory data is changed to a new data.
